(19) United States
(12) Patent Application Publication
(10) Pub. No.: US 2013/0044612 A1
(43) Pub. Date: Feb. 21, 2013

(54) AUTONOMOUS WI-FI BASED RANGING DEVICE

(71) Applicant: Olaf J. HIRSCH, Sunnyvale, CA (US)

(72) Inventor: Olaf J. HIRSCH, Sunnyvale, CA (US)

(21) Appl. No.: 13/211,192

(22) Filed: Aug. 16, 2011

(51) Int. Cl. H04W 24/00

(52) U.S. Cl. 370/252

(57) ABSTRACT

A method for autonomous ranging between Wi-Fi enabled mobile devices. A mobile device transmits a probe request to a target mobile device via a wireless channel, and receives a probe response from the target device. The probe response includes identification information associated with the target device. The mobile device uses the identification information to transmit a data packet to the target device via the wireless channel, and without communicating with any wireless access points. The mobile device then receives a reply packet from the target device and determines a distance to the target device based on a round trip time between the transmission of the data packet and the reception of the reply packet.

### TECHNICAL FIELD

The present embodiments relate generally to wireless communication, and specifically to detecting distances between Wi-Fi enabled mobile devices.

### BACKGROUND OF RELATED ART

In wireless communication networks, there are many known techniques for estimating the distance between a wireless local area network (WLAN) mobile device and a WLAN access point. For example, the WLAN mobile device (e.g., a cell phone or tablet computer) can use the received signal strength indicator (RSSI) corresponding to the WLAN access point as a rough approximation of the distance between the mobile device and the access point, where a stronger RSSI means that the mobile device is closer to the access point and a weaker RSSI means that the mobile device is further from the access point. The mobile device can also use the round trip time (RTT) of signals transmitted to and from the access points to calculate the distances between the mobile device and the access points, where the RTT value indicates the time elapsed between a message sent from the mobile device to the access point and a corresponding acknowledgement message sent from the access point to the mobile device.

Unlike WLAN clients, WLAN access points are typically stationary devices that simply relay data between devices on a network (e.g., wireless and/or wired clients). Thus, conventional WLAN distance estimation techniques have been limited in application due to their dependence upon the continued presence of and access to WLAN access points (e.g., the mobile device must be in range of at least one operational WLAN access point). For example, in mobile applications such as skydiving, a user must be aware of the presence of others around him. A wireless ranging device could be a useful tool to warn a skydiver about the presence of other skydivers within range of his canopy, so that he can choose not to engage in certain canopy maneuvers. However, absent the presence of wireless access points in such applications, conventional ranging techniques that are dependent upon access points are not feasible.

Accordingly, there is a need for a system and method of determining the distances between two or more mobile devices without the need to communicate through an access point.

### BRIEF DESCRIPTION OF THE DRAWINGS

The present embodiments are illustrated by way of example and are not intended to be limited by the figures of the accompanying drawings, where:

FIG. 1 depicts an autonomous ranging system, according to an embodiment.

FIG. 2 is a more detailed embodiment of one of the mobile devices shown in FIG. 1.

FIG. 3 is an exemplary application of an autonomous ranging system, according to an embodiment.

FIG. 4 is an exemplary application of an autonomous ranging system, according to another embodiment.

FIG. 5 is an exemplary application of an autonomous ranging system, according to yet another embodiment.

FIG. 6 is a flow chart depicting an operation of a mobile device having autonomous ranging functionality, according to an embodiment.

FIG. 7 is a flow chart depicting an operation of a mobile device having autonomous ranging functionality, according to another embodiment.

FIG. 8 is a block diagram of another embodiment of the mobile device shown in FIG. 1.

Like reference numerals refer to corresponding parts throughout the drawing figures.

### DETAILED DESCRIPTION

The present embodiments are discussed below in the context of autonomous ranging between Wi-Fi enabled devices in skydiving applications for simplicity only. It is to be understood that the present embodiments are equally applicable for ranging using signals of other various wireless standards or protocols, and in a variety of applications other than skydiving. In the following description, numerous specific details are set forth such as examples of specific components, circuits, software and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of myriad physical or logical mechanisms for communication between components.

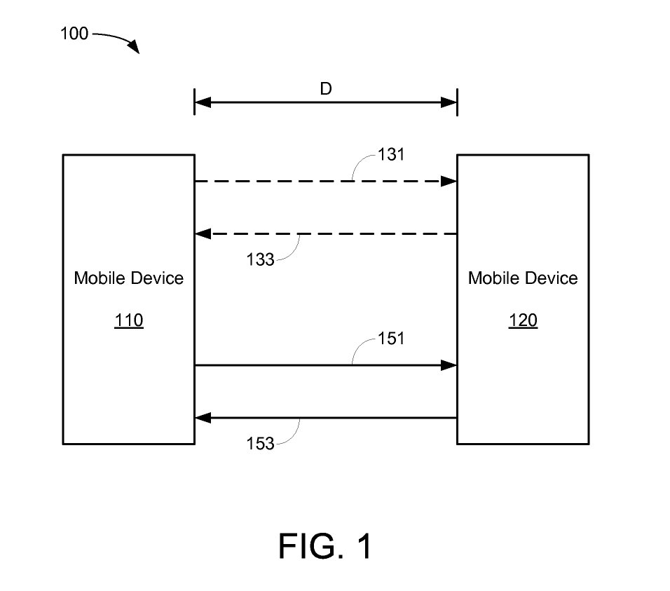

FIG. 1 shows an autonomous ranging system 100, according to an embodiment. The system 100 includes two mobile devices 110 and 120 separated by a distance D. The mobile devices 110 and 120 can include devices such as mobile phones, laptop computers, tablet computers, PDAs, and so on. For some embodiments, the mobile devices 110 and 120 are Wi-Fi enabled and can use Wi-Fi signals to exchange data with the Internet, LAN, WLAN, and/or VPN.

Note that the mobile devices 110 and 120 are not connected to each other via a wireless access point. Thus, the first mobile device 110 actively seeks out and communicates with the second mobile device 120. Since the mobile devices 110 and 120 do not communicate via a Wi-Fi access point in system 100, the first mobile device 110 is configured to determine identification information associated with the second mobile device 120 in order to communicate with the second mobile device 120. The identification information may include at least a media access control (MAC) address associated with the second mobile device 120 and/or a wireless channel on which the second mobile device 120 is configured to listen for (and transmit) data packets.

According to an embodiment, the first mobile device 110 transmits a probe request 131 to the second mobile device 120 to retrieve its identification information. For example, the first mobile device 110 may broadcast probe requests on several different channels until it finds the channel on which the second mobile device 120 is configured to operate. Alternatively, both the first mobile device 110 and the second mobile device 120 may be pre-configured to operate on the same channel for ranging purposes. The second mobile device 120 responds to the probe request 131 by transmitting a probe response 133 back to the first mobile device 110. The probe response includes identification information (e.g., a MAC address) associated with the second mobile device 120.

Once the first mobile device 110 knows the identification information of the second mobile device 120, it can then transmit a data packet 151 directly to the second mobile device 120 (e.g., in a “peer-to-peer” fashion). The second mobile device 120 responds to the data packet 151 by transmitting a reply packet 153 acknowledging receipt of the data packet 151. For some embodiments, the first mobile device 110 transmits data packets 151 to the second mobile device 120 without actually pairing or “handshaking” with the second mobile device 120. For example, the data packet 151 may correspond to a NULL frame, which does not carry any meaningful data but merely elicits a response from the second mobile device 120. Accordingly, the second mobile device 120 does not have to actually process the NULL frame, but rather merely acknowledges reception of a NULL frame by transmitting an acknowledgement frame back to the first mobile device 110. Note that the transmission of NULL frames and acknowledgement frames by the first and second mobile devices 110 and 120, respectively, may be performed according to standard Wi-Fi protocols.

The first mobile device 110 is configured to calculate the distance D to the second mobile device 120 based on a round trip time (RTT) associated with the system 100. The RTT represents the total time elapsed from the time the data packet 151 is transmitted from mobile device 110 to the time the reply packet 153 is received by mobile device 110. The RTT can also be represented, for example, based on a signal propagation time (tₚₙ) and a processing delay time (t_{del}) for the ranging system 100:

RTT=tₚₙ+t_{del} (1)

where tₚₙ represents the summation of the travel time of the data packet 151 transmitted from the first mobile device 110 to the second mobile device 120 and the travel time of the reply packet 153 from the second mobile device 120 back to the first mobile device 110, and t_{del} is the delay associated with the second mobile device 120 receiving the data packet 151 from the first mobile device 110 and transmitting the reply packet 153 back to the first mobile device 110. For some embodiments, t_{del} may be a known value associated with the second mobile device 120. Alternatively, t_{del} may correspond to the Short InterFrame Space (SIFS) time interval associated with the second mobile device 120, as defined by the 802.11 standard, or the Reduced InterFrame Space (RIFS) time interval, as defined by the 802.11n standard. The distance D between the first mobile device 110 and the second mobile device 120 can then be expressed as:

D=c*tₚₙ/2=c*(RTT−t_{del})/2 (2)

where c is the speed of light. For some embodiments, the value of RTT can be measured by the first mobile device 110 a plurality of times to generate an average round trip time value (RTTₐᵥ), in which case the value of RTTₐᵥ is used in Equation (2) instead of a single measured value RTT. In this manner, the first mobile device 110 is able to “autonomously” (i.e., without a Wi-Fi access point) determine the distance D to the second mobile device 120.

The autonomous ranging system 100 offers several advantages over conventional ranging systems. For example, because it does not depend on Wi-Fi access points, the ranging system 100 can be implemented just about anywhere, as long as the mobile devices 110 and 120 are within Wi-Fi range of one another and there are no other impediments to their ability to communicate with each other. This may be particularly advantageous in applications such as skydiving (described in greater detail below). Furthermore, the first and second mobile devices 110 and 120 may be identical devices. Thus, the second mobile device 120 may also be able to determine its distance D from the first mobile device 110 (e.g., in the same manner described above). Because the first mobile device 110 does not have to pair with the second mobile device 120, it may determine its distance D from the second mobile device 120 in a very quick and efficient manner. Additionally, this allows the first mobile device 110 to perform ranging operations with a plurality of other mobile devices concurrently.

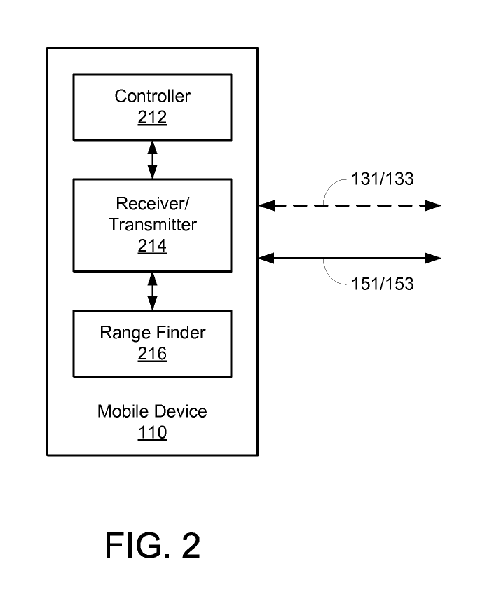

FIG. 2 shows a more detailed embodiment of the mobile device 110 shown in FIG. 1. The mobile device 110 includes a controller 212, a receiver/transmitter 214, and a range finder 216. The receiver/transmitter 214 includes circuitry for transmitting and receiving wireless data signals according to Wi-Fi or other known wireless protocols. The controller 212 enables the mobile device 110 to operate in a ranging mode, for example, by configuring the receiver/transmitter 214 to broadcast probe requests 131 (e.g., on one or more wireless channels) and listen for probe responses 133 to detect the presence of other mobile devices within range of the mobile device 110. The controller 212 also retrieves the identification information from received probe responses 133, and configures the receiver/transmitter 214 to transmit a data packet 151 to a mobile device associated with the retrieved identification information. For some embodiments, the controller 212 may also configure the receiver/transmitter 214 to respond to probe requests and/or data packets sent to the mobile device 110 from another device. For example, some conventional Wi-Fi clients may not be automatically responsive to incoming data packets in the absence of wireless access points. Thus, the controller 212 may configure the mobile device 110 to listen for incoming data packets (and probe requests) from another mobile device (e.g., a “peer” device), even when the mobile device 110 is not connected to a wireless access point.

The range finder 216 determines the distance from the mobile device 110 to another mobile device. For example, when the receiver/transmitter 214 transmits a data packet to another mobile device, the range finder 216 can detect and store the time instant at which the data packet 151 is transmitted from the mobile device 110. Similarly, when the receiver/transmitter 214 receives a reply packet from another mobile device, the range finder 216 can also detect and store the time instant at which the reply packet 153 is received at the mobile device 110. The range finder 216 can then calculate the RTT value based on the transmit time of the data packet and the receive time of the reply packet, according to Equation 1, and determine the distance D to the other mobile device based on the RTT value and the processing delay time t_{del} associated with the other mobile device, according to Equation 2.

The controller 212 can warn a user of the mobile device 110 if another mobile device is too close or too far from the mobile device 110 (e.g., if the distance D is greater than or less than a threshold distance D_{T}). For some embodiments, the controller 212 can determine the velocity at which another mobile device is travelling relative to the mobile device 110 based on successive distance calculations by the range finder 216. For example, the controller 212 may warn a user of the mobile device 110 if the user of another mobile device is on a collision course with him. In further embodiments, the mobile device 110 can include an altimeter (not shown) that can detect a distance between the mobile device 110 and the surface of the earth.

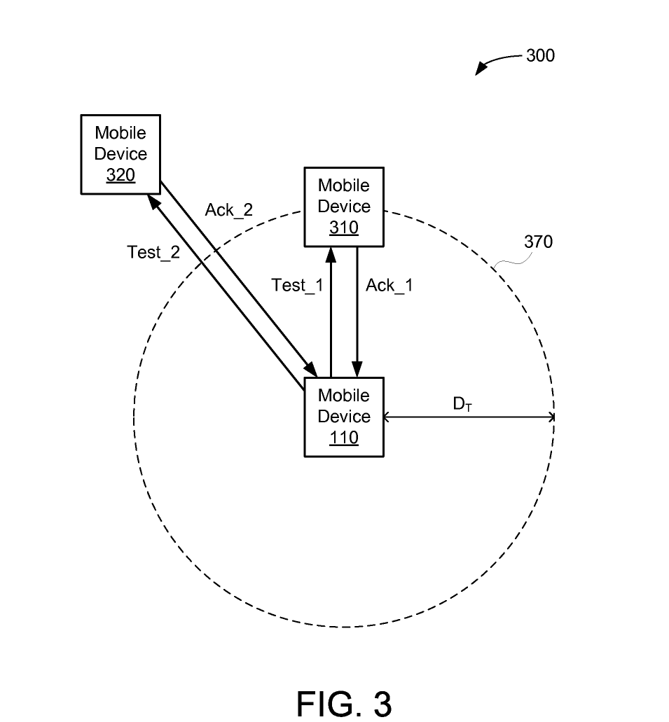

FIG. 3 shows an exemplary application of an autonomous ranging system 300, according to an embodiment. The system 300 includes the mobile device 110 and two other mobile devices 310 and 320. For simplicity, it is assumed that the mobile device 110 has already retrieved the identification information associated with each of the other mobile devices 310 and 320 (e.g., including a MAC address and/or a wireless channel on which each of the devices is configured to operate). Otherwise, the mobile device 110 can transmit probe requests to each of the mobile devices 310 and 320 to retrieve identification information for the devices (e.g., as described in the embodiments above). The mobile device 110 transmits data packets Test_1 and Test_2 to mobile devices 310 and 320, respectively. In turn, the mobile devices 310 and 320 acknowledge receipt of the data packets by transmitting respective reply packets, Ack_1 and Ack_2, back to the mobile device 110. The mobile device 110 can then determine its distance to each of the mobile devices 310 and 320 based on the RTT values associated with the transmitted data packets and the received reply packets (e.g., as described above). For some embodiments, the mobile device 110 is configured to continuously transmit data packets Test_1 and Test_2 to the mobile devices 310 and 320, respectively. In this manner, the mobile device 110 is able to determine up-to-date distance information at substantially regular intervals.

According to an embodiment, the mobile device 110 is configured to warn its user if other mobile devices are detected within a threshold distance (D_{T}) from the mobile device 110, as indicated by the range 370. In a specific example, each of the mobile devices 110, 310 and 320 is associated with a different skydiver in freefall. The range 370 may thus correspond to a safe distance from which the user of the mobile device 110 can deploy his parachute without risk of injuring others around him. When the mobile device 110 detects that mobile device 310 is within range 370, it can notify the user of the mobile device 110 that another skydiver is within an unsafe distance D_{T}. The notification may be in the form of a visual, audible, or physical cue. For example, the mobile device 110 can be configured to light up, sound an alarm, or vibrate once the mobile device 110 detects that the other mobile device 310 is within range 370. This allows the user of the mobile device 110 to respond by increasing his distance from the user of the mobile device 310. When the mobile device 110 detects that the mobile device 310 is no longer within range 370, it may turn off the notification or alarm. Because mobile device 320 is already a safe distance away from the mobile device 110 (i.e., outside the range 370), its presence does not cause the mobile device 110 to trigger any alarm or notification. For some embodiments, mobile device 110 can intensify the notification or alarm as the distance between mobile device 110 and the other device decreases.

Each of the mobile devices 310 and 320 can be further configured to determine their own respective distances from the mobile device 110 (e.g., in a similar manner as described above). Accordingly, both devices 110 and 310 can trigger respective alarms when they are within range 370 of one another. This enables users of both mobile devices 110 and 310 to respond by attempting to increase their distance from one another. For example, while under the canopy, the skydiver associated with mobile device 310 may want to initiate a high risk or high performance landing, and then upon detection of another skydiver in close range, the skydiver can abort the high performance landing and choose a landing style that is less risky.

In other embodiments, the mobile device 110 can warn its user when any of the mobile devices 310 and 320 are outside of the range 370. In such a case, the mobile device 110 can trigger an alarm in response to determining its distance from the mobile device 320, and not the mobile device 310. For some embodiments, the mobile device 310 can be configured to operate (e.g., to receive data packets) on a different wireless channel than mobile device 320. However, because the mobile device 110 does not handshake with either of the mobile devices 310 and 320, it can perform ranging operations with both devices 310 and 320 concurrently.

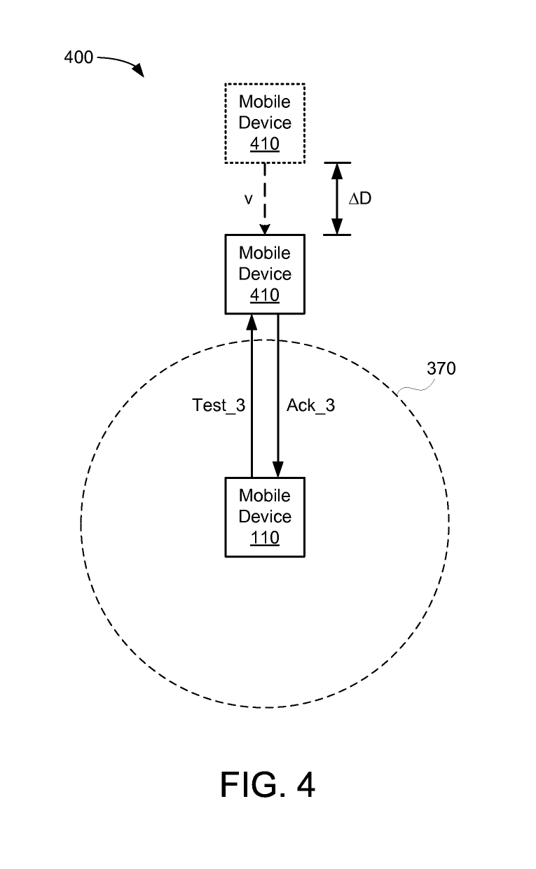

FIG. 4 shows an exemplary application of an autonomous ranging system 400, according to another embodiment. The system 400 includes the mobile device 110 and another mobile device 410. For simplicity, it is assumed that the mobile device 110 has already retrieved the identification information associated with the other mobile device 410. The mobile device 110 transmits data packets Test_3 to the mobile device 410, and the mobile device 410 transmits reply packets Ack_3 back to the mobile device 110. The mobile device 110 can then determine its distance from the mobile device 410 based on a RTT value associated with the transmitted data packets and the received reply packets.

For some embodiments, the mobile device 110 continuously transmits data packets Test_3 to the mobile device 410, and receives reply packets Ack_3 from the mobile device 410 (e.g., at substantially regular intervals). In this manner, the mobile device 110 is able to determine changes in the distance D (AD) between the mobile device 110 and the mobile device 410. The mobile device 110 can then determine a velocity (v) at which the mobile device 410 is travelling relative to the mobile device 110, according to the following equation:

v=(ΔD)/(Δt) (3)

where Δt is the amount of time elapsed between consecutive distance measurements. The change in time Δt may simply correspond to the interval or frequency with which the mobile device 110 is configured to transmit data packets Test_3 to the mobile device 410. Alternatively, Δt may be calculated, for example, based on the difference in timestamps recorded for consecutive data packets Test_3 or reply packets Ack_3 (or an average of the differences). Note that, a positive value of v denotes that at least one of the mobile devices 110 or 410 is travelling away from the other, whereas a negative value of v indicates that at least one of the mobile devices 110 or 410 is travelling towards the other. For some embodiments, the velocity v can be calculated based on an average change in distance (ΔD_{avg}) over an extended period of time (ΔT).

The velocity v is particularly useful for preventing collisions between objects travelling at high rates of speed. For example, as shown in FIG. 4, mobile device 410 is just outside of the “unsafe” range 370. However, the mobile device 110 may have previously detected the mobile device 410 to be even further away (e.g., as indicated by the change in distance AD). Based on its rate of travel, the mobile device 410 may be well within the unsafe distance 370 by the time the mobile device 110 performs a subsequent distance determination. By determining the velocity v at which the mobile device 410 is travelling, the mobile device 110 can warn a user (e.g., via a visual, audible, or physical notification) when the mobile device 410 is approaching dangerously close to the range 370. This may give the user of the mobile device 110 enough time to adjust his rate of speed or distance from the user of the mobile device 410 while they are still a safe distance apart.

The mobile device 410 can also be configured to determine changes in distance ΔD from the mobile device 110 (e.g., as described above). Accordingly, the device 410 can also trigger its own alarm when it is within range 370 of the mobile device 110. This enables users of both mobile devices 110 and 410 to respond by attempting to increase their distance from one another. For example, under canopy environment, the skydiver associated with mobile device 410 may try to slow down his velocity of travel in the direction of the skydiver associated with the mobile device 110, who, in turn, may try to increase his velocity of travel away from the skydiver associated with the mobile device 410. In other embodiments, the mobile device 110 can warn its user when the mobile device 410 is outside of the range 370.

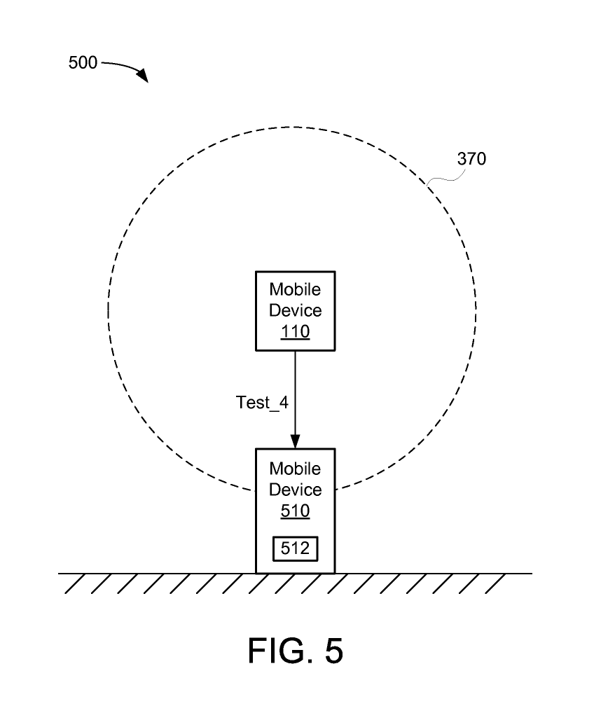

FIG. 5 shows an exemplary application of an autonomous ranging system 500, according to yet another embodiment. The system 500 includes the mobile device 110 and another mobile device 510. For simplicity, it is assumed that the mobile device 110 has already retrieved the identification information associated with mobile device 510. In the example shown, mobile device 510 is on the ground and does not respond to data packets Test_4 sent from the mobile device 110, which is still under canopy. This may be advantageous, for example, to prevent false warnings to a user of the mobile device 110 that another skydiver is within range 370 of his canopy (e.g., in his blind spot above him).

According to an embodiment, the mobile device 510 includes an altimeter 512 for detecting its distance to the ground or surface of the earth. When the altimeter 512 detects that the mobile device 510 has reached the ground, or dropped below a threshold altitude, it causes the mobile device 510 to stop replying to data packets Test_4 received from the mobile device 110. In some embodiments, the mobile device 110 can also have an altimeter that causes the mobile device 110 to stop transmitting reply packets to other devices when it reaches ground level.

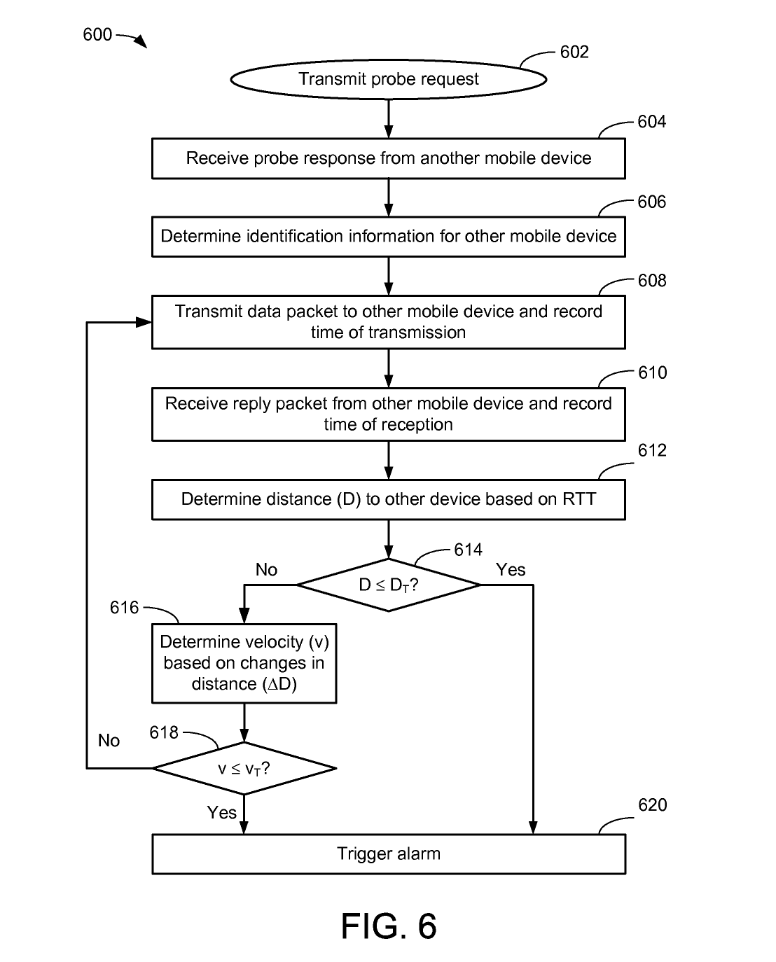

FIG. 6 shows a flow chart 600 depicting an operation of a mobile device having autonomous ranging functionality, according to an embodiment. At 602, the mobile device transmits a probe request to detect one or more other mobile devices within communication range. The mobile device can transmit the probe request on a specific wireless channel, for example, if all of the other mobile devices are preconfigured to listen for data packets on that particular channel. Alternatively, the mobile device can broadcast probe requests on a plurality of different channels, to “scan” for other devices, if the operating channels of the other devices are unknown.

The mobile device receives a probe response from another mobile device, at 604, and uses the probe response to determine identification information for that mobile device, at 606. The identification information includes at least a MAC address associated with the other mobile device, and/or a wireless channel on which the other mobile device is configured to listen for data packets. For example, the MAC address of the other mobile device can be retrieved from the probe response, and the operating channel of the other mobile device can be determined from the wireless channel on which the probe response was received.

Once the mobile device knows the identification information associated with the other mobile device (hereinafter, the “target device”), it can then transmit a data packet to that device, at 608. According to an embodiment, the mobile device transmits data packets to the target device without actually pairing or handshaking with that device, thus enabling the mobile device to transmit data packets to a plurality of other mobile devices concurrently. The data packet sent by the mobile device may be an empty NULL frame, for example, as defined by standard 802.11 protocols. The mobile device also records (e.g., stores) the time at which it transmits the data packet to the target device, at 608, for use in determining a RTT value between the mobile device and the target device.

At 610, the mobile device receives a reply packet from the target device and records the time of reception. According to an embodiment, the reply packet is simply an acknowledgement that the target device received the data packet transmitted at step 608. Then, at 612, the mobile device calculates the RTT value from the time of transmission of the data packet to the time of reception of the reply packet, and determines a distance D to the target device based on the RTT value and a processing delay time (t_{del}) associated with the target device (e.g., using Equation 2).

The mobile device determines, at 614, whether the target device is within a threshold distance D_{T} from the target device (i.e., if D≦D_{T}). For example, the threshold distance D_{T} may correspond to a range within which any target device is considered “dangerously” close to the mobile device. If the mobile device determines that the target device is within the threshold distance DT, it triggers an alarm, at 620, to notify a user of the mobile device that a user of the target device is dangerously close.

If the mobile device determines that the target device is outside of the threshold range, it proceeds to calculate a change in distance AD between the mobile device and the target device, and determines a velocity v of the target device based on the change in distance ΔD and the time interval over which it was measured (e.g., using Equation 3). Then, at 618, the mobile device determines whether, given its current distance D and its velocity v relative to the mobile device, the target device is expected to be within the threshold distance D_{T} from the mobile device the next time it performs a ranging operation (i.e., if D+(v*Δt)≦D_{T}, where Δt corresponds to the interval or frequency with which the mobile device transmits data packets to the target device). Note that this step can also be determined by comparing the velocity v with a threshold velocity v_{T} (e.g., if v≦v_{T}, where v_{T}=(D_{T}−D)/Δt), wherein a positive velocity v indicates that at least one of the mobile device or the target device is travelling away from the other, and a vice-versa.

If the mobile device determines that the target device is going to cross the distance threshold D_{T}, it proceeds to trigger the alarm, at 620. On the other hand, if the mobile device determines that the target device will not cross the distance threshold DT by the time a subsequent ranging operation is performed, it proceeds by transmitting another data packet to the target device, at 608.

Note that, the first time the mobile device calculates a distance D to the target device, the mobile device may not have enough data points to determine a change in distance ΔD. Thus, because there effectively has not yet been a change in distance ΔD, the value of ΔD may be set to zero. In alternative embodiments, the mobile device may trigger an alarm if the target device is, or is about to be, too far away from the mobile device (e.g., at decision block 614, D≧D_{T}; and at decision block 618, D+(v*Δt)≧D_{T}).

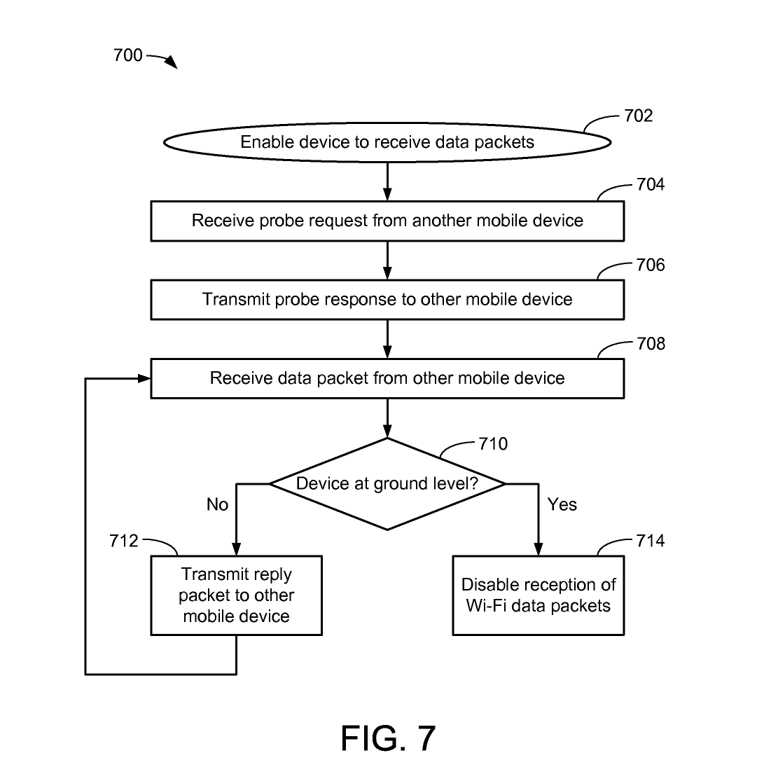

FIG. 7 shows a flow chart 700 depicting an operation of a mobile device, according to another embodiment. At 702, the mobile device is enabled to receive data packets over a particular wireless channel. For some embodiments, the mobile device is not connected to a wireless access point, but is nonetheless configured to listen for data packets from other mobile devices, at 702.

The mobile device receives a probe request from another mobile device, at 704, and transmits a probe response back to that mobile device (hereinafter, the “requesting device”), at 706. The probe response includes identification information associated with the mobile device, including at least a MAC address for the mobile device. The identification information allows the requesting device to then transmit a data packet directly to the mobile device, at 708, without going through a wireless access point (e.g., in a peer-to-peer fashion).

At 710, the mobile device determines whether it is at ground level, for example, using an altimeter. If the mobile device determines that it is not at ground level, or at least below a threshold altitude, it proceeds by transmitting a reply packet back to the requesting device, at 712, and waits to receive another data packet from the requesting device, at 708.

If the mobile device determines that it is at ground level, or below the threshold altitude, it proceeds by disabling reception of data packets, at 714. For example, this may correspond to turning off the mobile device's Wi-Fi radio (e.g., for power saving purposes). This further prevents the requesting device from receiving false warnings that the mobile device is an unsafe distance from the requesting device (e.g., within range of a skydiver's canopy). In alternative embodiments, the mobile device may still receive data packets sent from the requesting device, but simply suppresses the transmission of reply packets back to the requesting device, at 714.

FIG. 2 shows a more detailed embodiment of the mobile device 110 shown in FIG. 1. The mobile device 110 includes a controller 212, a receiver/transmitter 214, and a range finder 216. The receiver/transmitter 214 includes circuitry for transmitting and receiving wireless data signals according to Wi-Fi or other known wireless protocols. The controller 212 enables the mobile device 110 to operate in a ranging mode, for example, by configuring the receiver/transmitter 214 to broadcast probe requests 131 (e.g., on one or more wireless channels) and listen for probe responses 133 to detect the presence of other mobile devices within range of the mobile device 110. The controller 212 also retrieves the identification information from received probe responses 133, and configures the receiver/transmitter 214 to transmit a data packet 151 to a mobile device associated with the retrieved identification information. For some embodiments, the controller 212 may also configure the receiver/transmitter 214 to respond to probe requests and/or data packets sent to the mobile device 110 from another device. For example, some conventional Wi-Fi clients may not be automatically responsive to incoming data packets in the absence of wireless access points. Thus, the controller 212 may configure the mobile device 110 to listen for incoming data packets (and probe requests) from another mobile device (e.g., a “peer” device), even when the mobile device 110 is not connected to a wireless access point.

The range finder 216 determines the distance from the mobile device 110 to another mobile device. For example, when the receiver/transmitter 214 transmits a data packet to another mobile device, the range finder 216 can detect and store the time instant at which the data packet 151 is transmitted from the mobile device 110. Similarly, when the receiver/transmitter 214 receives a reply packet from another mobile device, the range finder 216 can also detect and store the time instant at which the reply packet 153 is received at the mobile device 110. The range finder 216 can then calculate the RTT value based on the transmit time of the data packet and the receive time of the reply packet, according to Equation 1, and determine the distance D to the other mobile device based on the RTT value and the processing delay time t_{del} associated with the other mobile device, according to Equation 2.

The controller 212 can warn a user of the mobile device 110 if another mobile device is too close or too far from the mobile device 110 (e.g., if the distance D is greater than or less than a threshold distance D_{T}). For some embodiments, the controller 212 can determine the velocity at which another mobile device is travelling relative to the mobile device 110 based on successive distance calculations by the range finder 216. For example, the controller 212 may warn a user of the mobile device 110 if the user of another mobile device is on a collision course with him. In further embodiments, the mobile device 110 can include an altimeter (not shown) that can detect a distance between the mobile device 110 and the surface of the earth.

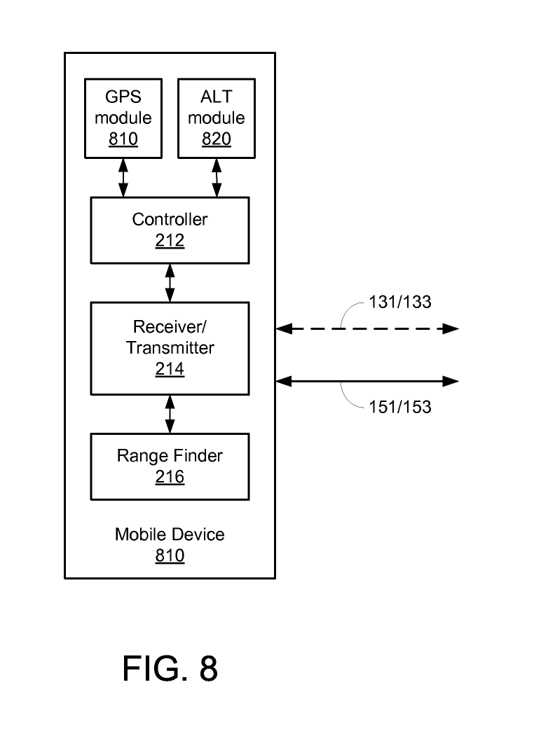

For other embodiments, mobile device 110 can also include a GPS module that provides absolute position and speed information to the user, which in turn can be used with altimeter information to increase the accuracy of the ranging calculations. For example, FIG. 8 shows a mobile device 800 that is another embodiment of mobile device 110. Mobile device 800 includes all the elements of mobile device 110 of FIG. 2, plus a GPS module 810 and an altimeter module 820. GPS module 810, which can include any well-known global positioning satellite (GPS) or navigation element, provides absolute position and speed information of mobile device 810 to its user. Altimeter module 820, which can be any well-known altimeter device or element, provides altitude information of mobile device 810 to its user. In operation, controller 212 can combine the absolute position and speed information provided by GPS module 810 with the altitude information provided by altimeter module 820 to increase the accuracy of the ranging calculations described above.

More specifically, for some embodiments, the absolute position, speed, and altitude information of mobile device 800 can be communicated to another (e.g., a target) mobile device (not shown for simplicity) by embedding such information in the data packet or frames sent from mobile device 800 to the target device. Similarly, the absolute position, speed, and altitude information of the target device can be communicated to mobile device 800 by embedding such information in the reply packets or frames sent from the target device to mobile device 800. In this manner, absolute position, speed, and altitude information of mobile device 800 and the target device can be exchanged between the devices using exchanged data frames (e.g., in a peer-to-peer fashion without using an access point). Of course, for such embodiments, the absolute position, speed, and altitude information of mobile device 800 and the target device can be exchanged using other suitable techniques.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. For example, while the exemplary embodiments are described above specifically in the context of Wi-Fi signals, the ranging operations performed by the present embodiments can be equally performed usually other wireless communications protocols.

Further, although described above with respect to skydiving applications, the present embodiments are equally applicable to other ranging applications. For one example, the present embodiments can be used by blind persons to alert them when they are approaching others having similarly equipped mobile devices. For another example, the present embodiments can be used by motorists to alert each other when they are within a dangerously close distance of one another (e.g., to avoid collisions).

What is claimed is:

1. A method of operating a mobile device, the method comprising:
transmitting a first probe request to a target mobile device via a wireless channel;
receiving a first probe response from the target mobile device, wherein the probe response includes identification information associated with the target mobile device;
transmitting a first data packet to the target mobile device, via the wireless channel and using the identification information;
receiving a first reply packet from the target mobile device; and
determining a first distance to the target mobile device based, at least in part, on a round trip time (RTT) between the transmission of the first data packet and the reception of the first reply packet.

2. The method of claim 1, wherein the mobile device transmits the first data packet to the target mobile device without communicating with any wireless access points.

3. The method of claim 1, wherein the first data packet is a NULL frame and the first reply packet is an acknowledgement frame.

4. The method of claim 1, further comprising:
selectively triggering an alarm based on the first distance to the target mobile device.

5. The method of claim 4, wherein the selectively triggering comprises triggering the alarm if the first distance is less than or equal to a threshold distance.

6. The method of claim 4, wherein the alarm includes at least one of a visual, audible, or physical notification.

7. The method of claim 4, wherein the alarm intensifies as the first distance decreases.

8. The method of claim 1, wherein the mobile device does not pair or handshake with the target mobile device.

9. The method of claim 1, further comprising:
recording a transmit time when the mobile device transmits the first data packet;
recording a receive time when the mobile device receives the first reply packet; and
determining the RTT based on the transmit time and the receive time.

10. The method of claim 1, wherein the identification information includes at least a media access control (MAC) address of the target mobile device.

11. The method of claim 1, further comprising:
transmitting a second data packet to the target mobile device;
receiving a second reply packet from the target mobile device; and
determining a second distance to the target mobile device based, at least in part, on a RTT between the transmission of the second data packet and the reception of the second reply packet.

12. The method of claim 11, further comprising:
determining a velocity of the target mobile device based, at least in part, on a difference between the first distance and the second distance.

13. A mobile communication device, comprising:
means for transmitting a first probe request to a target mobile device via a wireless channel;
means for receiving a first probe response from the target mobile device, wherein the probe response includes identification information associated with the target mobile device;
means for transmitting a first data packet to the target mobile device, via the wireless channel and using the identification information;
means for receiving a first reply packet from the target mobile device; and
means for determining a first distance to the target mobile device based, at least in part, on a round trip time (RTT) between the transmission of the first data packet and the reception of the first reply packet.

14. The device of claim 13, wherein the mobile device transmits the first data packet to the target mobile device without communicating with any wireless access points.

15. The device of claim 13, wherein the first data packet is a NULL frame and the first reply packet is an acknowledgement frame.

16. The device of claim 13, further comprising:
means for selectively triggering an alarm based on the first distance to the target mobile device.

17. The device of claim 16, wherein the means for selectively triggering is configured to trigger the alarm if the first distance is less than or equal to a threshold distance.

18. The device of claim 13, wherein the alarm includes at least one of a visual, audible, or physical notification.

19. The device of claim 13, wherein the mobile device does not pair or handshake with the target mobile device.

20. The device of claim 13, further comprising:
means for recording a transmit time when the mobile device transmits the first data packet;
means for recording a receive time when the mobile device receives the first reply packet; and
means for determining the RTT based on the transmit time and the receive time.

21. The device of claim 13, wherein the identification information includes at least a media access control (MAC) address of the target mobile device.

22. The device of claim 13, further comprising:
means for transmitting a second data packet to the target mobile device;
means for receiving a second reply packet from the target mobile device; and
means for determining a second distance to the target mobile device based, at least in part, on a RTT between the transmission of the second data packet and the reception of the second reply packet.

23. The device of claim 22, further comprising:
means for determining a velocity of the target mobile device based, at least in part, on a difference between the first distance and the second distance.

24. The device of claim 13, further comprising:
a GPS component configured to determine an absolute position of the mobile communication device.

25. The device of claim 24, further comprising:
means for communicating the absolute position of the mobile communication device to the target device.

26. The device of claim 25, wherein the absolute position of the mobile communication device is communicated to the target device by embedding the absolute position within the first data packet.
